(19) United States
(12) Patent Application Publication
(10) Pub. No.: US 2024/0356176 A1
(43) Pub. Date: Oct. 24, 2024

(54) METHOD AND SYSTEM FOR A PRISMATIC BATTERY CELL ASSEMBLY

(71) Applicant: GM GLOBAL TECHNOLOGY OPERATIONS LLC, Detroil, MI (US)

(72) Inventors: Andrew P. Oury, Troy, MI (US); Liang Xi, Northville, MI (US); Binsong Li, Troy, MI (US); SriLakshmi Katar, Troy, MI (US)

(73) Assignee: GM GLOBAL TECHNOLOGY OPERATIONS LLC, Detroit, MI (US)

(21) Appl. No.: 18/303,821

(22) Filed: Apr. 20, 2023

(51) Int. Cl. H01M 50/54; H01M 10/0585; H01M 50/103; H01M 50/533; H01M 50/536

(52) U.S. Cl. CPC H01M 50/54; H01M 10/0585; H01M 50/103; H01M 50/533; H01M 50/536

(57) ABSTRACT

A prismatic battery cell assembly has a prismatic container that includes a body portion composed of opposed first and second side portions, opposed first and second end portions, a bottom portion, and a top portion. An electrode stack is composed as anodes interleaved with cathodes. Each of the anodes includes a first current collector having an uncoated anode current collector portion that extends in a first direction away from the electrode stack, and each of the cathodes includes a second current collector having an uncoated cathode current collector portion that extends in a second direction away from the electrode stack. A first terminal is joined to the uncoated anode current collector portions of the first current collectors of the anodes, and a terminal is joined to the uncoated cathode current collector portions of the second current collectors of the cathodes.

### INTRODUCTION

DC power sources, such as batteries, are electrochemical devices that may be employed to store and release electric power that may be employed by an electric circuit or an electric machine to perform work, such as for communications, display, or propulsion. Heat may be generated by the processes of converting electric power to chemical potential energy, i.e., battery charging, and converting chemical potential energy to electric power, i.e., battery discharging.

A lithium battery is a rechargeable electrochemical device that operates by reversibly passing lithium ions between a negative electrode (or anode) and a positive electrode (or cathode). The negative and positive electrodes are situated on opposite sides of a porous polymer separator that is soaked with an electrolyte solution that is capable of conducting lithium ions. Each of the negative and positive electrodes is also accompanied by a respective current collector. The current collectors of the two electrodes are connected by an external circuit that allows an electric current to pass between the electrodes to electrically balance migration of lithium ions.

A battery may be composed of multiple battery cells that may be connected in series, in parallel, or a combination thereof to provide electric power at a predetermined voltage level. Electrical interconnections between terminals of the cells may be accomplished via bus bars and other devices. Each interconnection, bus bar, junction, terminal, additional part, etc., may add impedance, which may be undesirable. Prismatic cells may use tabs to connect the stacked electrodes to cell terminals.

### SUMMARY

There is a benefit to having lower electrical cell resistance to enable higher power, better thermal performance, and longer cycle life in a battery cell.

The concepts described herein include a prismatic battery cell assembly wherein the configuration of a plurality of battery cells contained in the prismatic container reduces or eliminates quantities of electrical interconnections between the plurality of battery cells, and/or quantities of electrical interconnections between the plurality of battery cells and either or both the positive terminals and negative terminals. The concepts described herein also include an apparatus and associated method for a prismatic battery cell assembly having a prismatic container that functions as one or both the positive and the negative terminal.

This may include a tabless design whereby elements of an electrode stack are directly joined to an element of a prismatic container without tab connections. A tabless design provides the flexibility of joining the electrode stack to the prismatic container side, end, top, or bottom, thus enabling shorter current conduction lengths in the electric circuit and resulting in lower electrical resistance. It also increases the flexibility of bussing location. The tabless concept may also be used to prismatic cells having wound cells. The tabless arrangement may be placed on either a long side of the battery electrodes, or a short side of the battery electrodes. When the tabless arrangement is placed on the long side of the battery electrodes, it may shorten current conduction paths, resulting in reduced electrical resistance.

An aspect of the disclosure may include a prismatic battery cell assembly having a prismatic container that includes a body portion composed of opposed first and second side portions, opposed first and second end portions, a bottom portion, and a top portion. An electrode stack is composed as a plurality of anodes interleaved with a plurality of cathodes. Each of the plurality of anodes includes a first current collector having an uncoated anode current collector portion that extends in a first direction away from the electrode stack, and wherein each of the cathodes includes a second current collector having an uncoated cathode current collector portion that extends in a second direction away from the electrode stack, wherein the second direction is opposite to the first direction. A first current collector plate is joined to the uncoated anode current collector portions of the first current collectors of the plurality of anodes, and a second current collector plate is joined to the uncoated cathode current collector portions of the second current collectors of the plurality of cathodes. A first terminal is joined to the first current collector plate, and a second terminal is joined to the second current collector plate.

Another aspect of the disclosure may include one of the opposed first and second side portions, the opposed first and second end portions, the bottom portion, or the top portion being fabricated from an electrically conductive material and arranged as the first terminal.

Another aspect of the disclosure may include the one of the opposed first and second side portions, the opposed first and second end portions, the bottom portion, or the top portion of the prismatic container being electrically isolated.

Another aspect of the disclosure may include the first terminal being electrically isolated and arranged on one of the opposed first and second side portions, the opposed first and second end portions, the bottom portion, or the top portion of the prismatic container.

Another aspect of the disclosure may include the second terminal being electrically isolated and arranged on one of the opposed first and second side portions, the opposed first and second end portions, the bottom portion, or the top portion of the prismatic container.

Another aspect of the disclosure may include the first current collector plate being joined to the uncoated anode current collector portions of the first current collectors of the plurality of anodes via a laser weld.

Another aspect of the disclosure may include the first current collector plate being joined to the uncoated anode current collector portions of the first current collectors of the plurality of anodes via an electrically conductive paste.

Another aspect of the disclosure may include the first current collector plate being joined to the uncoated anode current collector portions of the first current collectors of the plurality of anodes via solder.

Another aspect of the disclosure may include a tabless prismatic battery cell assembly that includes a prismatic container, the prismatic container including a body portion composed of opposed first and second side portions, opposed first and second end portions, a bottom portion, and a top portion. An electrode stack is composed as a plurality of anodes interleaved with a plurality of cathodes, with separators interposed therebetween. Each of the plurality of anodes includes a first current collector having an uncoated anode current collector portion that extends in a first direction away from the electrode stack, and each of the plurality of cathodes includes a second current collector having an uncoated cathode current collector portion thereof that extends in a second direction away from the electrode stack, wherein the second direction is opposite to the first direction. A first terminal is joined to the uncoated anode current collector portions of the first current collectors of the plurality of anodes; and a second terminal is joined to the uncoated cathode current collector portions of the second current collectors of the plurality of cathodes.

Another aspect of the disclosure may include a method for assembling a prismatic battery cell that includes fabricating a prismatic container, the prismatic container including a body portion composed of opposed first and second side portions, opposed first and second end portions, a bottom portion, and a top portion. A plurality of anodes are fabricated, wherein each of the plurality of anodes includes a first current collector having an uncoated anode current collector portion that extends in a first direction. A plurality of cathodes are fabricated, wherein each of the plurality of cathodes includes a second current collector having an uncoated cathode current collector portion that extends in a second direction. An electrode stack is formed by interleaving the plurality of anodes with the plurality of cathodes, with separators interposed therebetween. The uncoated anode current collector portion is folded in a first direction, and then a portion of the uncoated anode current collector portion is folded back in a second direction. The uncoated cathode current collector portion is folded in the first direction, and then a portion of the uncoated cathode current collector portion is folded back in a second direction. The uncoated anode current collector portions of the plurality of anodes are joined to a first terminal; and the uncoated cathode current collector portions of the plurality of cathodes are joined to a second terminal.

The above summary is not intended to represent every possible embodiment or every aspect of the present disclosure. Rather, the foregoing summary is intended to illustrate some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an electrified drivetrain for a vehicle including a rechargeable energy storage system and charging system, in accordance with the disclosure.

FIG. 2 schematically illustrates a cutaway isometric view of an embodiment of a prismatic battery cell assembly for a rechargeable energy storage system, in accordance with the disclosure.

FIGS. 3A, 3B, and 3C schematically illustrate side views of embodiments of an anode, separator, and cathode for a prismatic battery cell assembly, in accordance with the disclosure.

FIG. 4 schematically illustrates an end view of an embodiment of an electrode stack for a prismatic battery cell assembly, in accordance with the disclosure.

FIG. 5 schematically illustrates an end view of another embodiment of an electrode stack for a prismatic battery cell assembly, in accordance with the disclosure.

FIG. 6 schematically illustrates a cutaway isometric view of an embodiment of a prismatic battery cell assembly for a rechargeable energy storage system, in accordance with the disclosure.

The appended drawings are not necessarily to scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is illustrative in nature and is not intended to limit the application and uses. Furthermore, there is no intention to be bound by any expressed or implied theory presented herein. Throughout the drawings, corresponding reference numerals indicate like or corresponding parts and features.

Referring to the drawings, wherein like reference numerals correspond to like or similar components, FIG. 1 schematically illustrates elements related to a vehicle 100 including an electrified drivetrain 10 and a rechargeable energy storage system (RESS) 12, which is couplable via power cord and connector 25 to an electric power supply 11 via a charger 13. The vehicle 100 may include, but is not limited to, a mobile platform in the form of a commercial vehicle, industrial vehicle, agricultural vehicle, passenger vehicle, aircraft, watercraft, train, all-terrain vehicle, personal movement apparatus, robot, and the like to accomplish the purposes of this disclosure.

The electric power supply 11 is coupled to an electric power source originating from a public or a private electric power supplier, and is arranged to channel electric power via the power cord and connector 25 to the RESS 12 via the charger 13 when the vehicle 100 is stationary. The electric power may be delivered at nominal voltage levels of 120 VAC, 240 VAC, 360 VAC, 480 VAC, or another voltage level without limitation. The power cord and connector 25 may be an Electric Vehicle Supply Equipment (EVSE) device, or another device, without limitation.

The electrified drivetrain 10 may include an electric drivetrain that employs only electrical devices to generate tractive power, such as electric motor/generators. Alternatively, the electrified drivetrain 10 may be a hybrid electric drivetrain that employs multiple devices to generate electric power and/or tractive torque, such as an internal combustion engine or a fuel cell, for example.

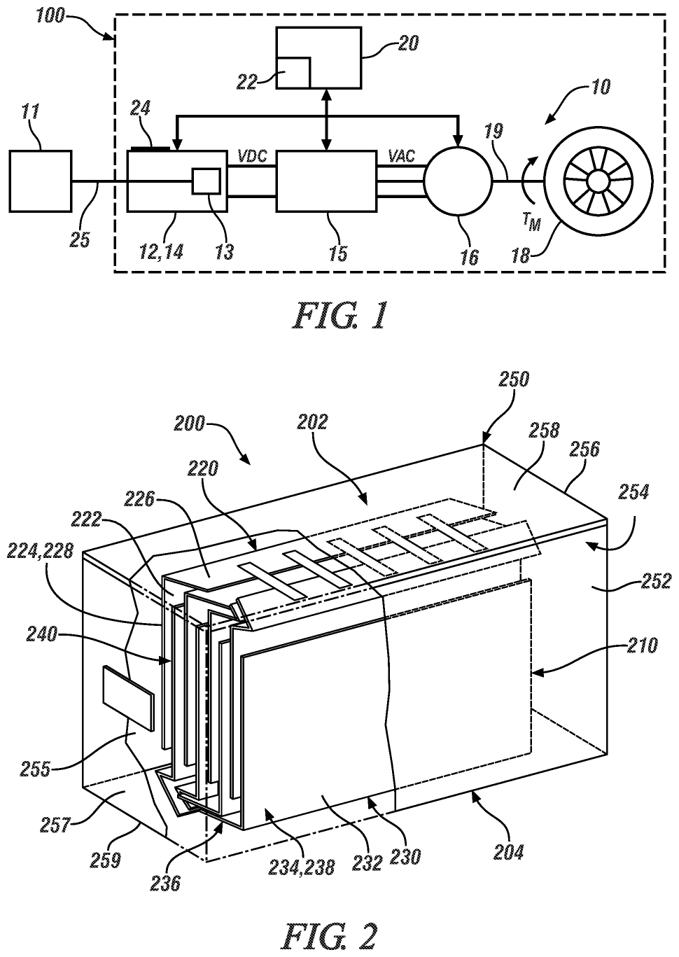

As illustrated, the electrified drivetrain 10 includes the RESS 12, power inverter 15, an electric machine 16, and a drive wheel 18. The RESS 12 is electrically coupled to and provides electrical energy (VDC) to one or more power sources, such as the electric machine 16, via the power inverter 15. The electric machine 16 provides tractive torque (T_{M}) 19 to the drive wheel 18. The RESS 12 is composed of one or a plurality of battery cell module assemblies (BCMA) 14, details of which are illustrated and described with reference to FIGS. 2, et seq. The RESS 12 is connected to the charger 13, which includes a charging inlet port into which the connector 25 may be plugged for purposes of charging the RESS 12 when the vehicle 100 is stationary. The charger 13 is an electric device that is controllable by a direct-current fast charge (DCFC) control routine 22 that is executed by a controller 20 to manage electric power flow to the RESS 12. The controller 20 is arranged to monitor the RESS 12, the power inverter 15, and the electric machine 16. The controller 20 also includes a non-transitory digital data storage medium on which a control routine 22 is stored in one or multiple encoded datafiles that are executable by a processor of the controller 20. An embodiment of the control routine 22 is described with reference to FIG. 2. The controller 20 may also include control routines for monitoring and controlling operations of the power inverter 15 and the electric machine 16. One or multiple heat exchangers 24 may be in thermal contact with the RESS 12 and the inverter 15 to effect heat transfer.

Various embodiments of the concepts described herein provide a prismatic battery cell assembly that employs a tabless arrangement that is achieved by directly joining an electrode stack to a portion of the prismatic container without tab connections. The tabless arrangement joins the electrode stack to a side, end, top or bottom of the prismatic container, which enables shorter current conduction lengths in the electric circuit and results in lower electrical resistance compared to known arrangements. It also increases flexibility in locating buses. The tabless concept may also be used to prismatic cells with cylindrical arrangements of the electrode stack. The reduced electrical cell resistance may enable high power, better thermal performance, and longer cycle life.

FIG. 2 schematically illustrates an embodiment of a prismatic battery cell assembly 200 that employs a tabless arrangement to electrically connect elements thereof.

The prismatic battery cell assembly 200 includes an electrode stack 210 that is arranged within a prismatic container 250, a first, negative terminal 202, and a second, positive terminal 204. The prismatic container 250 includes a body portion 252, a top portion 258, and a bottom portion 259. The body portion 252 is composed of opposed first and second side portions 254, 255, respectively, and opposed first and second end portions 256, 257, respectively. One or more of the elements of the prismatic container 250, or portions thereof, may be fabricated from electrically conductive material, such as aluminum, aluminum alloy, titanium, stainless steel, etc. This enables the respective element(s) to function as and become either the first terminal 202 or the second terminal 204 when electrically connected to an element of the electrode stack 250.

One or more of the first and second side portions 254, 255, respectively, opposed first and second end portions 256, 257, respectively, the top portion 258, and/or the bottom portion 259 of the prismatic container 250 may be electrically isolated from other portions of the prismatic container 250, as shown with reference to FIG. 2, or may be fabricated from an electrically insulative material to electrically isolate the respective element. This facilitates placement of a terminal post for the first, negative terminal 202, and/or the second, positive terminal 204 that may be electrically connected to an element of the electrode stack 250.

The electrode stack 210 is composed as a plurality of anodes 220 that are interleaved with a plurality of cathodes 230, with separators 240 arranged therebetween. An element of the plurality of anodes 220 is electrically connected to the negative terminal 202, and an element of the plurality of cathodes 230 is electrically connected to the positive terminal 204.

Each of the anodes 220 includes an anode current collector 222 that is a solid or woven planar sheet that is fabricated from copper, a copper alloy, or another material. The anode current collector 222 has a first portion 224 and a second portion 226. The second portion 226 is also referred to as an uncoated anode current collector portion 226.

The first portion 224 is coated with anodic material 228. The second portion 226 is uncoated, and extends in a first direction away from the electrode stack 210, e.g., vertically downward as shown.

Each of the cathodes 230 includes a cathode current collector 232 that is a solid or woven planar sheet that is fabricated from aluminum, an aluminum alloy, or another material. The cathode current collector 232 has a first portion 234 and a second portion 236. The second portion 236 is also referred to as an uncoated cathode current collector portion 236. The first portion 234 is coated with cathodic material 238. The second portion 236 is uncoated, and extends in a second direction away from the electrode stack 210, e.g., vertically upward as shown.

The first portion 224 of each of the anodes 220 has an area that is co-extensive with an area of the first portion 234 of each of the cathodes 230.

The separator 240 is a permeable membrane containing an electrolyte, and is a planar sheet having an area that is co-extensive with the areas of the first portions 234 of the plurality of cathodes 230 and the first portions 224 of the plurality of anodes 220.

In this embodiment, the body portion 252 of the prismatic container 250 is electrically isolated from the top portion 258. In this embodiment, the first portions 224 of the plurality of anodes 220 are joined to the top portion 258, with the top portion 258 functioning as the negative terminal 202. In this embodiment, the first portions 234 of the plurality of cathodes 230 are joined to at least one of the elements of the body portion 252, with the resistive element of the body portion 252 functioning as the positive terminal 204.

The process of joining the plurality of anodes 220 to the top portion 258, and joining the plurality of cathodes 230 to the body portion 252 may include joining via laser welding, joining via soldering, or joining via application of conductive paste. Laser welding, soldering, and application of conductive paste are known, and thus not described in detail herein.

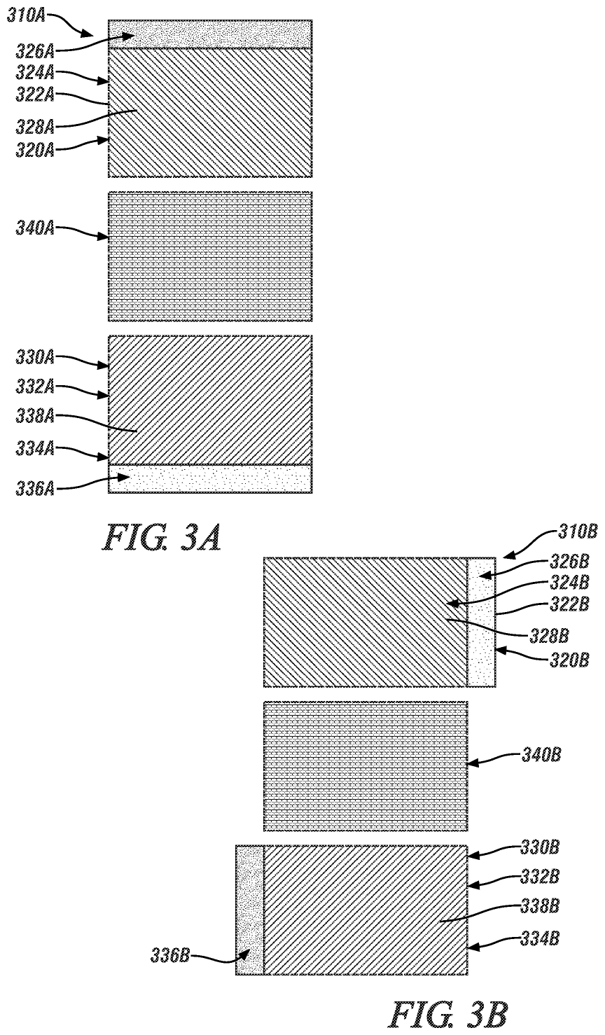

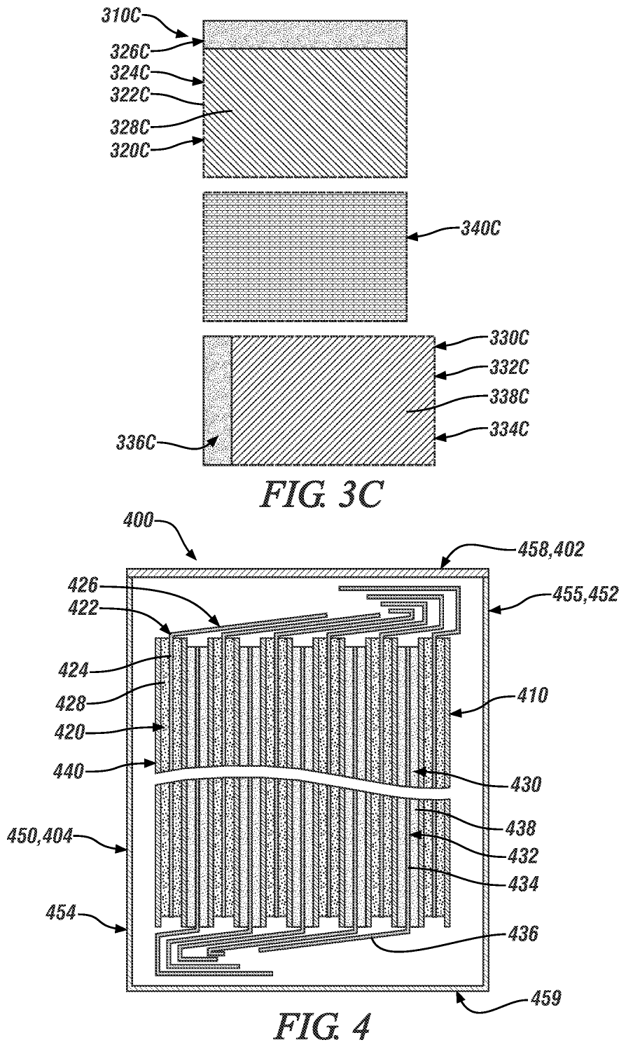

FIGS. 3A, 3B, and 3C schematically illustrate arrangements of embodiments of an anode, separator, and cathode that may be assembled into an electrode stack.

FIG. 3A schematically illustrates an embodiment of elements of electrode stack 310A, including an anode 320A, separator 340A, and cathode 330A. The anode 320A includes anode current collector 322A with a first portion 324A and a second portion 326A. The first portion 324A is coated with anodic material 328A. The second portion 326A is uncoated, i.e., is an uncoated anode current collector portion, and extends vertically upward away from the electrode stack 310A. The cathode 330A includes a cathode current collector 332A that is a planar sheet that is fabricated from aluminum, an aluminum alloy, or another material. The cathode current collector 332A has a first portion 334A and a second portion 336A. The first portion 334A is coated with cathodic material 338A. The second portion 336A is uncoated, i.e., is an uncoated cathode current collector portion, and extends vertically downward away from the electrode stack 310A. The surface area of the separator 340A is greater than the surface area of the first portion 324A of the anode 320A, which is greater than the surface area of the first portion 334A of the cathode 330A. The surface areas of the first portion 324A of the anode 320A, the first portion 334A of the cathode 330A, and the separator 340A are coextensive when assembled into the stack 310A.

FIG. 3B schematically illustrates another embodiment of elements of electrode stack 310B, including an anode 320B, separator 340B, and cathode 330B. The anode 320B includes anode current collector 322B with a first portion 324B and a second portion 326B. The first portion 324B is coated with anodic material 328B. The second portion 326B is uncoated, i.e., is an uncoated anode current collector portion, and extends horizontally leftward away from the electrode stack 310B. The cathode 330B includes a cathode current collector 332B that is a planar sheet that is fabricated from aluminum, an aluminum alloy, or another material. The cathode current collector 332B has a first portion 334B and a second portion 336B. The first portion 334B is coated with cathodic material 338B. The second portion 336B is uncoated, i.e., is an uncoated cathode current collector portion, and extends horizontally rightward away from the electrode stack 310B. The surface area of the separator 340B is greater than the surface area of the first portion 324B of the anode 320B, which is greater than the surface area of the first portion 334B of the cathode 330B. The surface areas of the first portion 324B of the anode 320B, the first portion 334B of the cathode 330B, and the separator 340B are coextensive when assembled into the stack 310B. FIG. 3C schematically illustrates another embodiment of elements of electrode stack 310C, including an anode 320C, separator 340C, and cathode 330C. The anode 320C includes anode current collector 322C with a first portion 324C and a second portion 326C. The first portion 324C is coated with anodic material 328C. The second portion 326C is uncoated, i.e., is an uncoated anode current collector portion, and extends horizontally leftward away from the electrode stack 310C. The cathode 330C includes a cathode current collector 332C that is a planar sheet that is fabricated from aluminum, an aluminum alloy, or another material. The cathode current collector 332C has a first portion 334C and a second portion 336C. The first portion 334C is coated with cathodic material 338C. The second portion 336C is uncoated, i.e., is an uncoated cathode current collector portion, and extends vertically upward away from the electrode stack 310C. The surface area of the separator 340C is greater than the surface area of the first portion 324C of the anode 320C, which is greater than the surface area of the first portion 334C of the cathode 330C. The surface areas of the first portion 324C of the anode 320C, the first portion 334C of the cathode 330C, and the separator 340C are coextensive when assembled into the stack 310C.

FIG. 4 schematically illustrates an end view of an embodiment of a prismatic battery cell assembly 400 that employs a tabless arrangement to electrically connect elements thereof. The prismatic battery cell assembly 400 includes an electrode stack 410 that is arranged within a prismatic container 450, a first, positive terminal 402, and a second, negative terminal 404. The prismatic container 450 includes a body portion 452, a top portion 458, and a bottom portion 459. The body portion 452 is composed of opposed first and second side portions 454, 455, respectively. Opposed first and second end portions are not illustrated. Elements of the electrode stack 410 include a plurality of anodes 420, a plurality of separators 440, and a plurality of cathodes 430, which are interleaved. Each anode 420 includes anode current collector 422 with a first portion 424 and a second portion 426. The first portion 424 is coated with anodic material 428. The second portion 426 is uncoated, i.e., is an uncoated anode current collector portion, and extends vertically upward away from the electrode stack 410. The plurality of second portions 426 of the plurality of anodes 420 are folded and overfolded, and then joined together and joined to the top portion 458 of prismatic container 450, which becomes and functions as the first terminal 402. Each cathode 430 includes a cathode current collector 432 that is a planar sheet that is fabricated from aluminum, an aluminum alloy, or another material. The cathode current collector 432 has a first portion 434 and a second portion 436. The first portion 434 is coated with cathodic material 438. The second portion 436 is uncoated, i.e., is an uncoated cathode current collector portion, and extends vertically downward away from the electrode stack 410. The plurality of second portions 436 of the plurality of cathodes 430 are folded and overfolded, and then joined together and joined to the body portion 452 of prismatic container 450, which becomes and functions as the second terminal 404. The surface area of the separator 440 is greater than the surface area of the first portion 424 of the anode 420, which is greater than the surface area of the first portion 434 of the cathode 430. The surface areas of the first portion 424 of the anode 420, the first portion 434 of the cathode 430, and the separator 440 are coextensive when assembled into the stack 410.

Each electrode in the electrode stack will leave a predefined length of exposed aluminum or copper current collector as tabs at either edge. One or both tabs can be folded, flattened, and welded to the prismatic metal case in a tabless configuration.

The folded current collectors directly welded to the case may be either the aluminum, or copper, or both.

The folded current collectors will extend out of the electrode stack on the stack edge, which can be folded back, so the folded current collectors will not extend out of the electrode stack.

The folded current collectors can be flattened for welding to a current collector plate or the prismatic container.

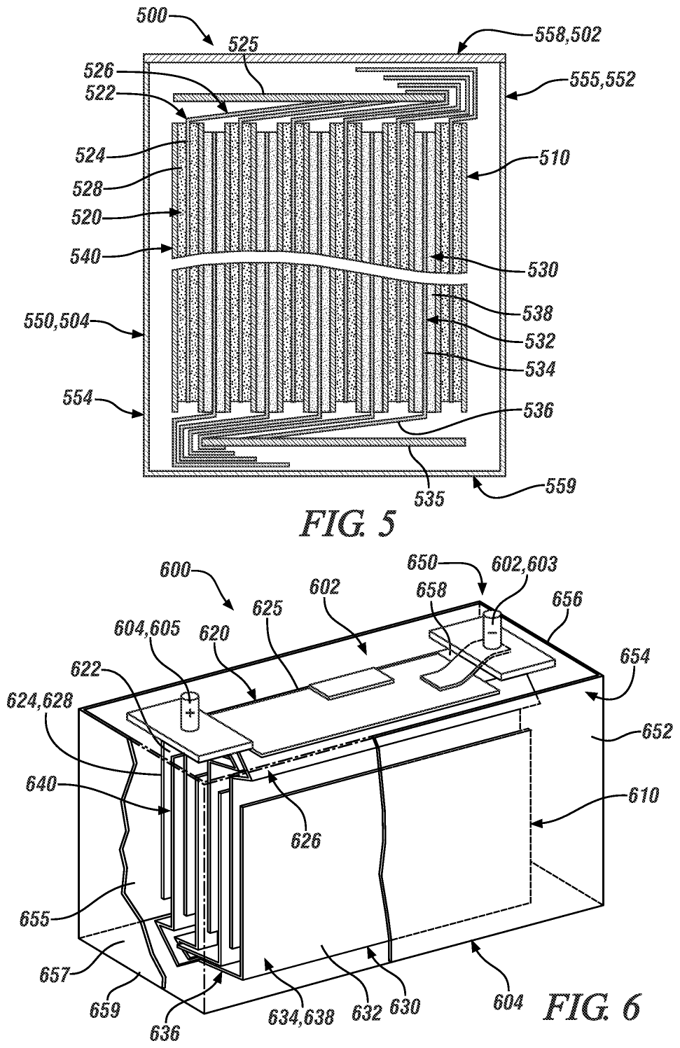

FIG. 5 schematically illustrates an end view of another embodiment of a prismatic battery cell assembly 500 that employs a tabless arrangement to electrically connect elements thereof. The prismatic battery cell assembly 500 includes an electrode stack 510 that is arranged within a prismatic container 550, a first, positive terminal 502, and a second, negative terminal 504. The prismatic container 550 includes a body portion 552, a top portion 558, and a bottom portion 559. The body portion 552 is composed of opposed first and second side portions 554, 555, respectively. Opposed first and second end portions are not illustrated. Elements of the electrode stack 510 include a plurality of anodes 520, a plurality of separators 540, and a plurality of cathodes 530, which are interleaved. Each anode 520 includes anode current collector 522 with a first portion 524 and a second portion 526. The first portion 524 is coated with anodic material 528. The second portion 526 is uncoated, i.e., is an uncoated anode current collector portion, and extends vertically upward away from the electrode stack 510. The plurality of second portions 526 of the plurality of anodes 520 are folded and overfolded around a first current collector plate 525, and then joined to the first current collector plate 525. The first current collector plate 525 may be joined to the first terminal 502, which may be located on the top portion 558 of prismatic container 550 or at another location on the prismatic container 550. Each cathode 530 includes a cathode current collector 532 that is a planar sheet that is fabricated from aluminum, an aluminum alloy, or another material. The cathode current collector 532 has a first portion 534 and a second portion 536. The first portion 534 is coated with cathodic material 538. The second portion 536 is uncoated, i.e., is an uncoated cathode current collector portion, and extends vertically downward away from the electrode stack 510. The plurality of second portions 536 of the plurality of cathodes 530 are folded and overfolded around a second current collector plate 535, and then joined to the second current collector plate 535. The second current collector plate 535 may be joined to the second terminal 504, which may be located on the top portion 558 of prismatic container 550 or at another location on the prismatic container 550. The surface area of the separator 540 is greater than the surface area of the first portion 524 of the anode 520, which is greater than the surface area of the first portion 534 of the cathode 530. The surface areas of the first portion 524 of the anode 520, the first portion 534 of the cathode 530, and the separator 540 are coextensive when assembled into the stack 510.

FIG. 6 schematically illustrates another embodiment of a prismatic battery cell assembly 600 that employs a tabless arrangement to electrically connect elements thereof.

The prismatic battery cell assembly 600 includes an electrode stack 610 that is arranged within a prismatic container 650, a first, negative terminal 602, and a second, positive terminal 604. The prismatic container 650 includes a body portion 652, a top portion 658, and a bottom portion 659. The body portion 652 is composed of opposed first and second side portions 654, 655, respectively, and opposed first and second end portions 656, 657, respectively. One or more of the elements of the prismatic container 650, or portions thereof, may be fabricated from electrically conductive material, such as aluminum, aluminum alloy, titanium, stainless steel, etc.

The first, negative terminal 602, and the second, positive terminal 604 are arranged on the top portion 658 in one embodiment.

This enables the respective element(s) to function as and become either the first terminal 602 or the second terminal 604 when electrically connected to an element of the electrode stack 610.

One or more of the first and second side portions 654, 655, respectively, opposed first and second end portions 656, 657, respectively, the top portion 658, and/or the bottom portion 659 may be electrically isolated from other portions by an electrically insulative gasket, or may be fabricated from an electrically insulative material to electrically isolate the respective element. This facilitates placement of terminal post 603 for the first, negative terminal 602 on the top portion 658, and placement of terminal post 605 for the second, positive terminal 604 on the top portion 658.

The electrode stack 610 is composed as a plurality of anodes 620 that are interleaved with a plurality of cathodes 630, with separators 640 arranged therebetween. An element of the plurality of anodes 620 is electrically connected to the negative terminal 602, and an element of the plurality of cathodes 630 is electrically connected to the positive terminal 604.

Each of the anodes 620 includes an anode current collector 622 that is a solid or woven planar sheet that is fabricated from copper, a copper alloy, or another material. The anode current collector 622 has a first portion 624 and a second portion 626. The second portion 626 is also referred to as an uncoated anode current collector portion 626.

The first portion 624 is coated with anodic material 628. The second portion 626 is uncoated, and extends in a first direction away from the electrode stack 610, e.g., vertically upward as shown.

Each of the cathodes 630 includes a cathode current collector 632 that is a solid or woven planar sheet that is fabricated from aluminum, an aluminum alloy, or another material. The cathode current collector 632 has a first portion 634 and a second portion 636. The second portion 636 is also referred to as an uncoated cathode current collector portion 636. The first portion 634 is coated with cathodic material 638. The second portion 636 is uncoated, and extends in a second direction away from the electrode stack 610, e.g., vertically downward as shown.

The second portions 626, i.e., the uncoated anode current collector portions 626, for the plurality of anode current collectors 622 are folded in a manner analogous to that described with reference to FIG. 5, and are joined to a first connector plate 625, which is electrically connected to the first, negative terminal 602.

The first portion 624 of each of the anodes 620 has an area that is co-extensive with an area of the first portion 634 of each of the cathodes 630.

The separator 640 is a permeable membrane containing an electrolyte, and is a planar sheet having an area that is co-extensive with the areas of the first portions 634 of the plurality of cathodes 630 and the first portions 624 of the plurality of anodes 620.

In this embodiment, the body portion 652 of the prismatic container 650 is electrically isolated from the top portion 658. In this embodiment, the first portions 624 of the plurality of anodes 620 are joined to the top portion 658, with the top portion 658 functioning as the negative terminal 602. In this embodiment, the first portions 634 of the plurality of cathodes 630 are joined to at least one of the elements of the body portion 652, e.g., bottom portion 659, with the resistive element of the body portion 652 functioning as the positive terminal 604.

The concepts described herein enable a prismatic battery cell assembly having an electrode stack wherein either the plurality of cathode current collectors or the plurality of anode current collectors is electrically connected to the prismatic container, and the other of the plurality of cathode current collectors or the plurality of anode current collectors is electrically connected to an external battery terminal post, thus enabling charging of the electrode stack, and reducing internal parts otherwise necessary for connecting to a second external battery terminal post.

The concepts described herein also enable a prismatic battery cell assembly having an electrode stack wherein either the plurality of cathode current collectors or the plurality of anode current collectors is electrically connected to a first portion of the prismatic container, and the other of the plurality of cathode current collectors or the plurality of anode current collectors is electrically connected to a second portion of the prismatic container, wherein the first portion of the prismatic container is electrically isolated from the second portion of the prismatic container, thus enabling charging of the electrode stack, and reducing internal parts otherwise necessary for connecting to a second external battery terminal post.

In some embodiments, the plurality of anode current collectors is joined to a first portion of the prismatic container via a first or anode current collector plate. In some embodiments, the plurality of anode current collectors is directly joined to the first portion of the prismatic container.

In some embodiments, the plurality of cathode current collectors is joined to a second portion of the prismatic container via a first or cathode current collector plate. In some embodiments, the plurality of cathode current collectors is directly joined to the second portion of the prismatic container.

One of the common current collectors can be welded to the prismatic metal case in a tabless configuration, and the other can be welded to the external battery terminal through a regular tab connection as a single tabless prismatic cell design.

The folded current collectors may be directly welded to the case, which may be either aluminum, copper, or alloys thereof. The folded current collectors may be pre-weld to a current collector plate then weld to the case or weld to the case directly without the current collector plate, thus charging the case to the same potential as the current collector connected (positive or negative).

In one embodiment, one tab may be eliminated inside the cell that otherwise connects to an external terminal, reducing part counts.

The tabs may be connected in either a P type (positive and negative terminals on the same side of the cell can) or N type (positive and negative terminals on the opposite side of the cell can) or other type configuration.

Implementation of an embodiment of the tabless configuration of the prismatic battery cell assembly may reduce or minimize electronic resistance.

Implementation of a tabless prismatic battery cell assembly enables bussing flexibility of the cells.

In one embodiment, each of the prismatic battery cell assemblies is a rechargeable lithium-metal or lithium-ion (lithium) battery cell. A lithium battery generally operates by reversibly passing lithium ions between a negative electrode (or anode) and a positive electrode (or cathode). The negative and positive electrodes are situated on opposite sides of a porous polymer separator that is soaked with an electrolyte solution suitable for conducting lithium ions. Each of the negative and positive electrodes is also accommodated by a respective current collector. The current collectors associated with the two electrodes are connected by an interruptible external circuit that allows an electric current to pass between the electrodes to electrically balance the related migration of lithium ions. Further, the negative electrode may include a lithium intercalation host material, and the positive electrode may include a lithium-based active material that can store lithium ions at a higher electric potential than the intercalation host material of the negative electrode.

During a discharge process, lithium ions (Li+) flow from the negative to the positive electrode, through the electrolyte solution and separator diaphragm. Electrons flow from the negative electrode to the positive electrode through the outer circuit, powering the electronic devices. When the lithium ions and electrons combine at the positive electrode, lithium is deposited there. During charging, an external electrical power source (the charging circuit) applies an over-voltage, forcing a charging current to flow within each cell from the positive to the negative electrode. The lithium ions then migrate from the positive to the negative electrode, where they become embedded in the porous electrode material in a process known as intercalation. Battery cell parameters include voltage, current, temperature, etc.

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A prismatic battery cell assembly, comprising:
a prismatic container, the prismatic container including a body portion composed of opposed first and second side portions, opposed first and second end portions, a bottom portion, and a top portion;
an electrode stack, the electrode stack being composed as a plurality of anodes interleaved with a plurality of cathodes;
wherein each of the plurality of anodes includes a first current collector having an uncoated anode current collector portion that extends in a first direction away from the electrode stack;
wherein each of the plurality of cathodes includes a second current collector having an uncoated cathode current collector portion thereof that extends in a second direction away from the electrode stack, wherein the second direction is opposite to the first direction;
a first current collector plate, the first current collector plate being joined to the uncoated anode current collector portions of the first current collectors of the plurality of anodes;
a second current collector plate, the second current collector plate being joined to the uncoated cathode current collector portions of the second current collectors of the plurality of cathodes;
a first terminal, the first terminal being joined to the first current collector plate; and
a second terminal, the second terminal being joined to the second current collector plate.

2. The prismatic battery cell assembly of claim 1, wherein one of the opposed first and second side portions, the opposed first and second end portions, the bottom portion, or the top portion is fabricated from an electrically conductive material and is arranged as the first terminal.

3. The prismatic battery cell assembly of claim 2, wherein the one of the opposed first and second side portions, the opposed first and second end portions, the bottom portion, or the top portion is electrically isolated.

4. The prismatic battery cell assembly of claim 1, wherein the first terminal is electrically isolated and arranged on one of the opposed first and second side portions, the opposed first and second end portions, the bottom portion, or the top portion.

5. The prismatic battery cell assembly of claim 4, wherein the second terminal is electrically isolated and arranged on one of the opposed first and second side portions, the opposed first and second end portions, the bottom portion, or the top portion.

6. The prismatic battery cell assembly of claim 1, wherein the first current collector plate is joined to the uncoated anode current collector portions of the first current collectors of the plurality of anodes via a laser weld.

7. The prismatic battery cell assembly of claim 1, wherein the first current collector plate is joined to the uncoated anode current collector portions of the first current collectors of the plurality of anodes via an electrically conductive paste.

8. The prismatic battery cell assembly of claim 1, wherein the first current collector plate is joined to the uncoated anode current collector portions of the first current collectors of the plurality of anodes via solder.

9. A tabless prismatic battery cell assembly, comprising:
a prismatic container, the prismatic container including a body portion composed of opposed first and second side portions, opposed first and second end portions, a bottom portion, and a top portion;
an electrode stack, the electrode stack being composed as a plurality of anodes interleaved with a plurality of cathodes;
wherein each of the plurality of anodes includes a first current collector having an uncoated anode current collector portion that extends in a first direction away from the electrode stack;
wherein each of the plurality of cathodes includes a second current collector having an uncoated cathode current collector portion thereof that extends in a second direction away from the electrode stack, wherein the second direction is opposite to the first direction;
a first terminal, the first terminal being joined to the uncoated anode current collector portions of the first current collectors of the plurality of anodes; and
a second terminal, the second terminal being joined to the uncoated cathode current collector portions of the second current collectors of the plurality of cathodes.

10. The tabless prismatic battery cell assembly of claim 9, wherein one of the opposed first and second side portions, the opposed first and second end portions, the bottom portion, or the top portion is fabricated from an electrically conductive material and is arranged as the first terminal.

11. The tabless prismatic battery cell assembly of claim 10, wherein the one of the opposed first and second side portions, the opposed first and second end portions, the bottom portion, or the top portion is joined to the first portions of the first current collectors of the plurality of anodes.

12. The tabless prismatic battery cell assembly of claim 10, wherein the one of the opposed first and second side portions, the opposed first and second end portions, the bottom portion, or the top portion is joined to the uncoated anode current collector portions of the plurality of anodes via one of a laser weld, a solder weld, or an electrically conductive paste.

13. The tabless prismatic battery cell assembly of claim 10, wherein the one of the opposed first and second side portions, the opposed first and second end portions, the bottom portion, or the top portion is electrically isolated.

14. The tabless prismatic battery cell assembly of claim 9, wherein the first terminal is electrically isolated and arranged on one of the opposed first and second side portions, the opposed first and second end portions, the bottom portion, or the top portion.

15. The tabless prismatic battery cell assembly of claim 14, wherein the second terminal is electrically isolated and arranged on one of the opposed first and second side portions, the opposed first and second end portions, the bottom portion, or the top portion.

16. A method for assembling a prismatic battery cell, the method comprising:
fabricating a prismatic container, the prismatic container including a body portion composed of opposed first and second side portions, opposed first and second end portions, a bottom portion, and a top portion;
fabricating a plurality of anodes, wherein each of the plurality of anodes includes a first current collector having an uncoated anode current collector portion that extends in a first direction;
fabricating a plurality of cathodes, wherein each of the plurality of cathodes includes a second current collector having an uncoated cathode current collector portion that extends in a second direction;
forming an electrode stack, including interleaving the plurality of anodes with the plurality of cathodes;
folding the uncoated anode current collector portion in a first direction;
folding back a portion of the uncoated anode current collector portion in a second direction;
folding the uncoated cathode current collector portion in a first direction;
folding back a portion of the uncoated cathode current collector portion in a second direction;
joining the uncoated anode current collector portions of the plurality of anodes to a first terminal; and
joining the uncoated cathode current collector portions of the plurality of cathodes to a second terminal.

17. The method of claim 16, wherein joining the uncoated anode current collector portions of the plurality of anodes to the first terminal comprises joining the uncoated anode current collector portions of the plurality of anodes to the first terminal via a first current collector plate.

18. The method of claim 16, wherein joining the uncoated cathode current collector portions of the plurality of cathode to the second terminal comprises joining the uncoated anode current collector portions of the plurality of cathodes to the second terminal via a second current collector plate.

19. The method of claim 16, wherein joining the uncoated anode current collector portions of the plurality of anodes to the first terminal comprises laser welding the uncoated anode current collector portions of the plurality of anodes to the first terminal.

20. The method of claim 16, wherein joining the uncoated anode current collector portions of the plurality of anodes to the first terminal comprises joining the uncoated anode current collector portions of the plurality of anodes to one of the opposed first and second side portions, the opposed first and second end portions, the bottom portion, or the top portion of the prismatic container.
